(19) United States
(12) Patent Application Publication
(10) Pub. No.: US 2025/0003288 A1
(43) Pub. Date: Jan. 2, 2025

(54) NEW MOTORIZED TWO-LAYER STRUCTURE SHADE

(71) Applicant: Ningbo Deyi Information Technology Co., LTD, Ningbo (CN)

(72) Inventor: Yiqing Yang, Ningbo (CN)

(73) Assignee: Ningbo Deyi Information Technology Co., LTD, Ningbo (CN)

(21) Appl. No.: 18/651,721

(22) Filed: May 1, 2024

(30) Foreign Application Priority Data
Jun. 29, 2023 (CN) 2023107857908

(51) Int. Cl. E06B 9/322; E06B 9/24; E06B 9/262

(52) U.S. Cl. CPC E06B 9/322; E06B 9/262; E06B 2009/2441; E06B 2009/2625; E06B 2009/3225

(57) ABSTRACT

A new motorized two-layer structure shade, includes a bottom beam (1); and a shell (2), a top of the shell (2) equipped with a first lifting component, a light-filtering fabric (3) installed on the first lifting component, and located between the bottom beam (1) and the shell (2), a first driving component is set on the shell (2), and a controller (27) electrically connected to the driving component also installed on the shell (2), the controller (27) configured to receive feedback data about position data of a distance between the bottom.

### CROSS REFERENCE TO RELATED APPLICATION

This non-provisional patent application claims priority under 35 U.S.C. §119 from Chinese Patent Application No. 202310785790.8 filed on Jun. 29, 2023, the entire content of which is incorporated herein by reference.

### TECHNICAL FIELD

This disclosure relates to curtain technologies, and in particularly relates to a new motorized two-layer structure shade.

### BACKGROUND

Nowadays, control modes of a curtain includes a manual mode and an motorized mode. The curtains with the manual mode include manual opening and closing of curtains, manual pull cord roller blinds, manual silk-like vertical blinds, manual zebra shades, manual wooden blinds, manual Roman blinds, manual accordion blinds, and more. The curtains with the motorized mode include motorized draperies, motorized roller blinds, motorized silk-like blinds, motorized fabric tension systems, motorized zebra shades, motorized wooden blinds, motorized roman blinds, motorized accordion blinds, and so on. With the development of curtains, the curtains have become indispensable interior decorations in living spaces, combining functionality and aesthetics. The curtains come in various types, and different types are used in different environments. In traditional curtain usage, a pull cord is used for operation, which limits the time and spatial range and has significant limitations. For example, in general dual-beam curtains, which include a top rail, a middle rail, a bottom rail, a cord reel, a window covering, a drive shaft, and a lifting reel that fixed on the bottom rail, and a lifting device and so on, and a mechanical structure for limiting is required to prevent collisions between the middle rail and the bottom rail.

However, in existing technologies, the lifting device requires mechanical structural for limiting to prevent collisions between the middle rail and the bottom rail, which significant shorten the service life of the curtains, and improvements are needed.

Therefore, there is an urgent need for a new motorized two-layer structure shade.

### SUMMARY

This disclosure provides a new motorized two-layer structure shade, which can resolve the short service life of the curtains.

The technical solution of the disclosure is as follows: a new motorized two-layer structure shade, includes a bottom beam (1); and a shell (2), a top of the shell (2) equipped with a first lifting component, a light-filtering fabric (3) installed on the first lifting component, and located between the bottom beam (1) and the shell (2), a first driving component is set on the shell (2), and a controller (27) electrically connected to the driving component also installed on the shell (2), the controller (27) configured to receive feedback data about position data of a distance between the bottom.

the driving component comprises a first outer tube (4) fixed on the shell (2) through a first bracket (24), a first motor (5) is installed inside the first outer tube (4) with a first motor outer cover (25), a first V-shaped shaft (6) is mounted on an output shaft of the first motor (5), and a first lithium battery (7) is set on the first bracket (24).

As a preferred embodiment, the first lifting component includes a first cord reel (8) installed on the first V-shaped shaft (6), and a first lifting rope (9) is mounted on the cord reel (8).

As a preferred embodiment, the first lifting rope (9) is equipped with a middle beam (10), and a translucent fabric (11) is installed between the middle beam (10) and the shell (2), the top of the shell (2) is equipped with a second lifting component, and a second driving component is installed on the bottom beam (1).

As a preferred embodiment, the driving component includes a second outer tube (12) fixed on the shell (2) through a second bracket (13). a second motor is installed inside the outer tube (12) via a second motor outer cover, a second V-shaped shaft (14) is mounted on an output shaft of the second motor, and the second bracket (13) is equipped with a second lithium battery (15).

As a preferred embodiment, the second lifting component includes a second cord reel (16) installed on the second V-shaped shaft (14), and a second lifting rope (17) is mounted on the second cord reel (16).

As a preferred embodiment, the shell (2) is equipped with an outer end cover (18), and the controller (27) is installed inside the outer end cover (18), the bottom beam (1) is equipped with a power board (19) electrically connected to the controller (27).

As a preferred embodiment, an angular velocity sensor is mounted to a bottom of the light-filtering fabric (3), the angular velocity sensor is electrically connected to the controller (27).

As a preferred embodiment, the shell (2) is equipped with dust-proof insert pieces (22).

As a preferred embodiment, a top of the dust-proof insert pieces (22) is symmetrically equipped with two mounting components (23).

### Advantageous Effects of the Disclosure

It provides an automated method to open and close the light filtering fabric, reducing user effort and increasing efficiency.

It nests the controller, motor, lithium battery, cord reel, etc., on the shell, and the symmetrically positioned brackets simplify installation, saving space and improving aesthetics.

It includes an angular velocity sensor on the bottom beam, enabling manual control of shade movement by detecting angle changes and sending signals to motor.

In this disclosure, the fabric corresponding to the middle beam and the fabric corresponding to the bottom beam are opened and closed by the controller. The fabric above the middle beam can detect the current position of the fabric above the bottom beam through the controller during the up and down movements. Similarly, the shade above the bottom beam can detect the current position of the fabric above the middle beam through the controller during the up and down movements. Both parts of the fabric can operate independently and simultaneously.

It uses rechargeable lithium batteries for power supply and can be supplemented with solar panels for energy efficiency.

### BRIEF DESCRIPTION OF THE DRAWINGS

To further illustrate the embodiment or technical solution of the present disclosure in the prior art, the following drawings will be briefly described. It is evident that these drawings are only a part of the embodiments of the present disclosure and do not limit the present disclosure. Ordinary skilled artisans in the field can obtain other drawings based on these drawings without creative labor.

FIG. 1 shows an exploded view of a new motorized two-layer structure shade in accordance with an embodiment.

FIG. 2 shows a relationship between the bottom beam and the driving components in accordance with an embodiment.

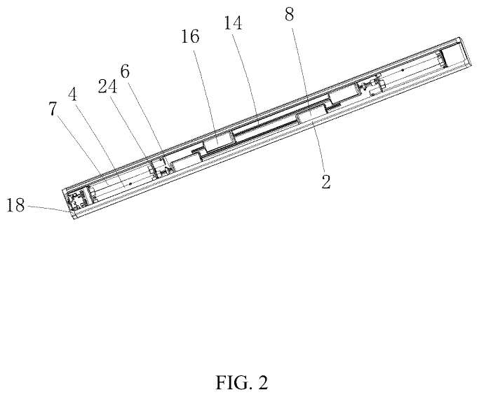

In the figures: 1. bottom beam; 2. shell; 3. blackout fabric; 4. first outer tube; 5. first motor; 6. first V-shaped shaft; 7. first lithium battery; 8. cord reel; 9. first lifting rope; 10. middle beam; 11. translucent shade fabric; 12. second outer tube; 13. bracket; 14. V-shaped shaft; 15. second battery outer tube; 16. second cord reel; 17. second lifting rope; 18. first outer end cap; 19. power board; 21. angular velocity sensor; 22. dustproof insert; 23. mounting piece; 24. bracket one; 25. first motor outer cove; 26. first outer battery tube; 27. controller.

### DETAILED DESCRIPTION OF THE EMBODIMENTS

The following will provide a clear and complete description of the technical solution in the exemplary embodiment of the present disclosure with reference to the accompanying drawings. It is evident that the described embodiment is only a part of the embodiments of the present disclosure, not all of them. Based on the embodiments in the present disclosure, all other embodiments that ordinary skilled persons in this field may obtain without creative work are within the scope of protection of the present disclosure.

### Embodiment

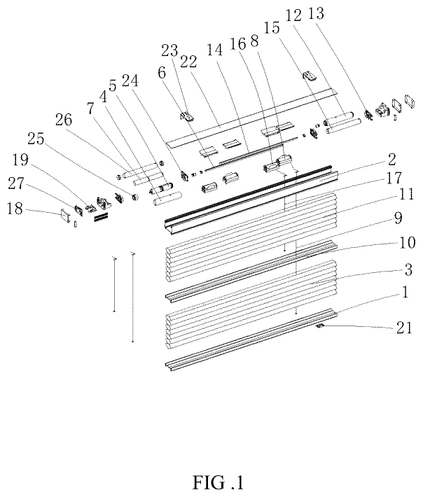

Referring FIG. 1, a new motorized two-layer structure shade includes a shell 2, a drive component disposed inside the shell 2. The drive component includes a first outer tube 4, the first outer tube 4 is fixed to the shell 2 by two brackets 24, and the two first brackets 24 are mutually symmetrical. An first outer motor cover 25 is installed at one end of the first outer tube 4, and a first motor 5 is installed on the outer motor cover 25. The first motor 5 is located inside the first outer tube 4. At the same time, a first V-shaped shaft 6 is installed on the output shaft of the first motor 5. The first motor 5 drives the first V-shaped shaft 6 to rotate through the output shaft of the first motor 5;

A first outer battery tube 26 is installed on the two brackets 24. A first lithium battery 7 is installed in the first outer battery tube 26. The first lithium battery 7 is electrically connected to the first motor 5, and the first lithium battery 7 supplies power to the first motor 5. At the same time, a first end cap and a second end cap are installed in the first outer tube 4. The first end cap and the second end cap are used to axially fix the first outer tube 4, reducing the possibility of the first lithium battery 7 moving within the first outer tube 4.

In this embodiment, there is a first lifting component in the shell 2. The first lifting component includes a cord reel 8. The cord reel 8 is set on the first V-shaped shaft 6, and the cord reel 8 is driven to rotate through the rotation of the first V-shaped shaft 6. There are two first cord reel 8 which are provided with a first lifting rope 9. The first lifting rope 9 is reeled or released on the first cord reel 8 through the rotation of the cord reel 8. Two first rope holes are symmetrically in the shell 2, and the two first lifting ropes 9 pass through the two first rope holes.

In this embodiment, there is a first drive component in the shell 2. The first drive component includes a second outer tube 12, the second outer tube 12 is fixed to the shell 2 by two second brackets 13, and the two second brackets 13 are mutually symmetrical. A second outer motor cover is installed at one end of the second outer tube 12, and a second motor is installed on the second outer motor cover. The second motor is located inside the second outer tube 12. At the same time, a second V-shaped shaft 14 is installed on the second output shaft of the second motor. The second motor drives the second V-shaped shaft 14 to rotate through the output shaft of the second motor.

Two second brackets 13 are provided with a second outer battery tube 15. A second lithium battery is installed in the second outer battery tube 15. The second lithium battery is electrically connected to the second motor, and the second lithium battery supplies power to the second motor. At the same time, a third end cap and a four end cap are installed in the second outer battery tube 15, and the third end cap and the fourth end cap are used to axially fix the second lithium battery, reducing the possibility of the second lithium battery moving inside the outer battery tube 15.

In this embodiment, there is a second lifting component in the shell 2. The second lifting component includes a second cord reel 16, the second cord reel 16 is set on the V-shaped shaft 14, and the second cord reel 16 is driven to rotate through the rotation of the second V-shaped shaft 14. There are two second cord reels which are provided with a second lifting rope 17. The second lifting rope 17 is reeled or released on the second cord reel 16 through the rotation of the second cord reel 16. Two second rope holes are symmetrically defined in the shell 2, and the two lifting ropes 17 pass through the two second rope holes.

In this embodiment, two translucent shade fabrics 11 are provided on the two second lifting ropes 17. By reeling or releasing the second lifting ropes 17, the translucent fabrics 11 are opened or folded. Users can selectively use the translucent fabrics 11 according to actual situations. Moreover, the two first lifting ropes 9 can pass through the translucent fabric 11.

In this embodiment, the middle beams 10 are provided on the two first lifting ropes 9. The middle beams 10 are positioned below the translucent fabric 11. In addition, blackout fabrics 3 are provided on the two first lifting ropes 9. By winding or releasing the two first lifting ropes 9, users can selectively open or fold the blackout fabrics 3 based on the actual circumstances.

Furthermore, a bottom beam 1 is installed at a bottom end of the first lifting ropes 9, and the bottom beam 1 is positioned below the blackout fabric 3. An angular velocity sensor 21 is mounted on a bottom of the bottom beam 1. The angular velocity sensor 21 is electrically connected to the first motor 5. The angular velocity sensor 21 detects if there are any obstacles during the movement of the translucent fabric 11. If one obstacle is detected, the angular velocity sensor 21 sends a signal to the first motor 5, causing the first motor 5 to rotate in reverse. As a result, the blackout fabric 3 moves in an opposite direction for a short distance, serving as a protective measure for the blackout fabric 3.

In this embodiment, first outer end caps 18 are installed at both outer ends of the shell 2. In addition, there are controllers 27 installed between the two first outer end caps 18 and the shell 2. These two controllers 27 are electrically connected to the first motor 5 and second motor, two power boards 19 are symmetrically installed on the bottom wall of the shell 2, and the power boards 19 are electrically connected to the two controllers 27. The two controllers 27 are capable of receiving feedback data through software programming. The position data between the middle beam 10 and the bottom beam 1 are recorded by the two controllers 27 at each time. The controllers then control the first motor 5 and the second motor should working or stop working that reduces the occurrence of collisions between the middle beam and the bottom beam, and increases the product's lifespan.

In this embodiment, dustproof inserts 22 are installed on the top of the shell 2. The dustproof inserts 22 are capable of preventing dust from entering inside the shell 2. In addition, there are two mounting pieces 23 installed on the top of the shell 2. The two mounting pieces 23 can includes seven installation codes. The users can secure the shell 2 to a pre-determined position using the installation codes.

In the disclosure, the blackout fabric 3 is opened all automatically that reduces the workload of users, and improving efficiency, saving time and effort.

The above description is only an exemplary embodiment of the disclosure and should not be construed as limiting the scope of the disclosure. Any modifications, equivalent replacements, improvements, etc., made within the spirit and principles of the disclosure should be included within the scope of protection of the disclosure.

1. A new motorized two-layer structure shade, comprising:
a bottom beam (1); and
a shell (2), a top of the shell (2) equipped with a first lifting component, a light-filtering fabric (3) installed on the first lifting component, and located between the bottom beam (1) and the shell (2), a first driving component is set on the shell (2), and a controller (27) electrically connected to the driving component also installed on the shell (2), the controller (27) configured to receive feedback data about position data of a distance between the bottom.

2. The new motorized two-layer structure shade of claim 1, wherein the driving component comprises a first outer tube (4) fixed on the shell (2) through a first bracket (24), a first motor (5) is installed inside the first outer tube (4) with a first motor outer cover (25), a first V-shaped shaft (6) is mounted on an output shaft of the first motor (5), and a first lithium battery (7) is set on the first bracket (24).

3. The new motorized two-layer structure shade of claim 2, wherein the first lifting component includes a first cord reel (8) installed on the first V-shaped shaft (6), and a first lifting rope (9) is mounted on the cord reel (8).

4. The new motorized two-layer structure shade of claim 3, wherein the first lifting rope (9) is equipped with a middle beam (10), and a translucent fabric (11) is installed between the middle beam (10) and the shell (2), the top of the shell (2) is equipped with a second lifting component, and a second driving component is installed on the bottom beam (1).

5. The new motorized two-layer structure shade of claim 4, wherein the driving component includes a second outer tube (12) fixed on the shell (2) through a second bracket (13). a second motor is installed inside the outer tube (12) via a second motor outer cover, a second V-shaped shaft (14) is mounted on an output shaft of the second motor, and the second bracket (13) is equipped with a second lithium battery (15).

6. The new motorized two-layer structure shade of claim 5, wherein the second lifting component includes a second cord reel (16) installed on the second V-shaped shaft (14), and a second lifting rope (17) is mounted on the second cord reel (16).

7. The new motorized two-layer structure shade of claim 1, wherein the shell (2) is equipped with an outer end cover (18), and the controller (27) is installed inside the outer end cover (18), the bottom beam (1) is equipped with a power board (19) electrically connected to the controller (27).

8. The new motorized two-layer structure shade of claim 1, wherein an angular velocity sensor is mounted to a bottom of the light-filtering fabric (3), the angular velocity sensor is electrically connected to the controller (27).

9. The new motorized two-layer structure shade of claim 1, wherein the shell (2) is equipped with dust-proof insert pieces (22).

10. The new motorized two-layer structure shade of claim 9, wherein a top of the dust-proof insert pieces (22) is symmetrically equipped with two mounting components (23).
